(19) United States
(12) Patent Application Publication
(10) Pub. No.: US 2020/0070571 A1
(43) Pub. Date: Mar. 5, 2020

(54) VEHICLE WHEEL

(71) Applicant: HONDA MOTOR CO., LTD., Tokyo (JP)

(72) Inventors: Yusuke OSAWA, Wako-shi (JP); Toshinobu SAITO, Wako-shi (JP); Youichi KAMIYAMA, Wako-shi (JP)

(21) Appl. No.: 16/553,848

(22) Filed: Aug. 28, 2019

(30) Foreign Application Priority Data
Aug. 30, 2018 (JP) 2018-161277

(51) Int. Cl. B60B 21/02; B60B 21/12; B60C 19/00

(52) U.S. Cl. CPC B60B 21/026; B60C 19/002; B60B 21/12

(57) ABSTRACT

A vehicle wheel includes: a rim including a well portion and a guide member, and a sub-air chamber member serving as a Helmholtz resonator. The well portion has an outer circumferential surface extending in a wheel circumferential direction of the vehicle wheel. The guide member has a rail-like shape and extends in the wheel circumferential direction along the outer circumferential surface. The guide member engages with the sub-air chamber member to guide the sub-air chamber member in the wheel circumferential direction, thereby to attach the sub-air chamber member to the rim.

### CROSS-REFERENCE TO RELATED APPLICATIONS

The present application claims priority under 35 U.S.C. § 119 to Japanese Patent Application No. 2018-161277, filed Aug. 30, 2018, the contents of which are hereby incorporated by reference in their entirety.

### BACKGROUND OF THE INVENTION

### 1. Field of the Invention

The present invention relates to a vehicle wheel.

### 2. Description of Related Art

There has been known a wheel including a well portion with an outer circumferential surface and a Helmholtz resonator (sub-air chamber member) that is attached to the outer circumferential surface and cancels air column resonance noises in a tire air chamber (e.g., see Japanese Patent No. 4551422). The sub-air chamber member of the wheel includes a main body portion formed elongated in a wheel circumferential direction and defining a sub-air chamber inside the main body, and a pair of plate-shaped edge portions that are formed on wheel width direction two ends of the main body along the substantially entire length of the main body portion in a longitudinal direction thereof to extend outward in a wheel width direction. The sub-air chamber member is attached to the well portion by distal ends of the pair of edge portions being fitted in groove portions formed in the well portion respectively.

The sub-air chamber member attached to the well portion via the pair of edge portions is curved extending from a bottom of the sub-air chamber member respectively to the pair of edge portions to be convex toward the outer circumferential surface of the well portion, so as to withstand the centrifugal force acting on the sub-air chamber member in a direction in which the sub-air chamber member separates off from the well portion. According to the structure of the sub-air chamber member, although the centrifugal force acts on the curved portions in such a way as to reverse the convex curve in the separating direction (centrifugal direction), the pressing force of the distal ends of the pair of edge portions against the groove portions increases and thus the sub-air chamber member can be retained on the well portion more firmly. In other words, according to the structure of the sub-air chamber member, the larger the centrifugal force, the sub-air chamber member is more firmly retained on the well portion.

### SUMMARY OF THE INVENTION

However, according to the structure of the conventional wheel with the sub-air chamber member (e.g., see Japanese Patent No. 4551422), the bottom of the sub-air chamber member is curved to be convex toward the outer circumferential surface of the well portion and is longitudinally curved along the wheel circumferential direction.

This structure of the conventional wheel makes it difficult to cause the sub-air chamber member, in particular the edge portions thereof, to be elastically deformed when attaching the sub-air chamber member to the well portion by fitting the edge portions of the sub-air chamber member into the groove portions of the well portion. Therefore, due to the structure of the conventional wheel, the sub-air chamber member needs to be attached to the well portion by pressing the pair of edge portions of the sub-air chamber member against the outer circumferential surface of the well portion using a large mechanical force produced by a pusher or the like.

An object of the present invention is to provide a vehicle wheel with a well portion which is excellent in retaining a sub-air chamber member and to which the sub-air chamber member can be attached in a simpler manner than the conventional vehicle wheel.

An aspect of the present invention is a vehicle wheel including: a rim including a well portion and a guide member, and a sub-air chamber member serving as a Helmholtz resonator. The well portion has an outer circumferential surface extending in a wheel circumferential direction of the vehicle wheel. The guide member has a rail-like shape and extends in the wheel circumferential direction along the outer circumferential surface. The guide member engages with the sub-air chamber member to guide the sub-air chamber member in the wheel circumferential direction, thereby to attach the sub-air chamber member to the rim.

The present invention provides a vehicle wheel with a well portion which is excellent in retaining a sub-air chamber member and to which the sub-air chamber member can be attached in a simpler manner than the conventional method.

### BRIEF DESCRIPTION OF THE DRAWINGS

FIG. 1 is a perspective view of a vehicle wheel according to an embodiment of the present invention.

FIG. 2 is an enlarged cross-sectional view of a sub-air chamber member, taken along a lengthwise direction thereof.

FIG. 3 is a cross-sectional view of the sub-air chamber member, taken along line in FIG. 2.

FIG. 4 is a cross-sectional view of the vehicle wheel, taken along a plane including the wheel rotation axis of the vehicle wheel. FIG. 4 illustrates how a guide member of the vehicle wheel extends.

FIG. 5A is a side view of a guide member according to a modification.

FIG. 5B is a cross-sectional view taken along line V-V in FIG. 5A.

### DETAILED DESCRIPTION OF THE PREFERRED EMBODIMENTS

Next, a vehicle wheel according to an embodiment of the present invention will be described in detail with reference to the drawings as appropriate. In the referenced drawings, “X” indicates a wheel circumferential direction, “Y” indicates a wheel width direction, and “Z” indicates a wheel radial direction.

A major feature of the vehicle wheel according to the present embodiment is that the vehicle wheel includes a rim with a rail-like guide member that guides a sub-air chamber member, which serves as a Helmholtz resonator, in the wheel circumferential direction.

Hereinafter, a description will be given of the whole structure of the vehicle wheel and then a description will be given of the sub-air chamber member and the guide member.

### Overall Configuration of Vehicle Wheel

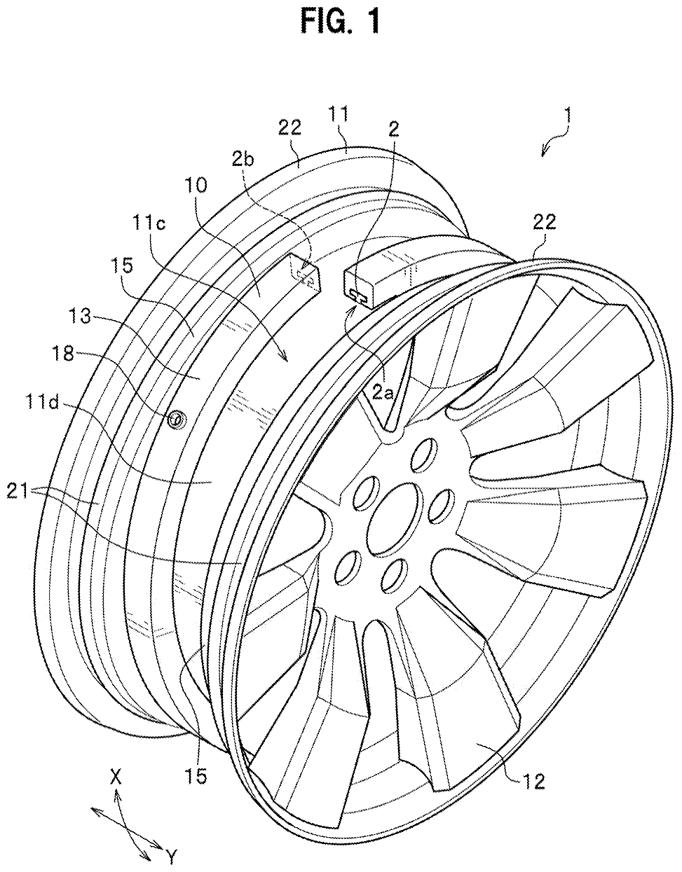

FIG. 1 is a perspective view of a vehicle wheel 1 according to an embodiment of the present invention.

As shown in FIG. 1, the vehicle wheel 1 according to the present embodiment has a rim 11 and a sub-air chamber member 10 (Helmholtz resonator) attached to the rim 11. The rim 11 is made of a metal such as an aluminum alloy or a magnesium alloy. The sub-air chamber member 10 is made of a flexible resin such as polypropylene or polyamide.

In FIG. 1, the reference numeral 12 denotes a disc for coupling the rim 11 to a hub not illustrated; the reference numeral 18 denotes the later-described tube body of the sub-air chamber member 10; and the reference numeral 2 denotes the guide member.

The rim 11 has widthwise end portions which are located opposite each other in the wheel width direction Y and at each of which a bead seat 21 is formed. The rim 11 has a well portion 11c recessed toward a wheel axis in the wheel radial direction between the bead seats 21. A bottom surface of this recess defines an outer circumferential surface 11d of the well portion 11c. The outer circumferential surface 11d has a substantially constant diameter about the wheel axis along the wheel width direction Y.

The rim 11 includes a pair of vertical walls 15 that rise toward rim flanges 22 of the rim 11 respectively from widthwise ends of the outer circumferential surface 11d of the well portion 11c which are located opposite each other in the wheel width direction Y. The rim 11 rises from the vertical walls 15 via the bead seats 21 outward in the wheel width direction Y toward the rim flanges 22.

### Sub-Air Chamber Member

Next, a description will be given of the sub-air chamber member 10.

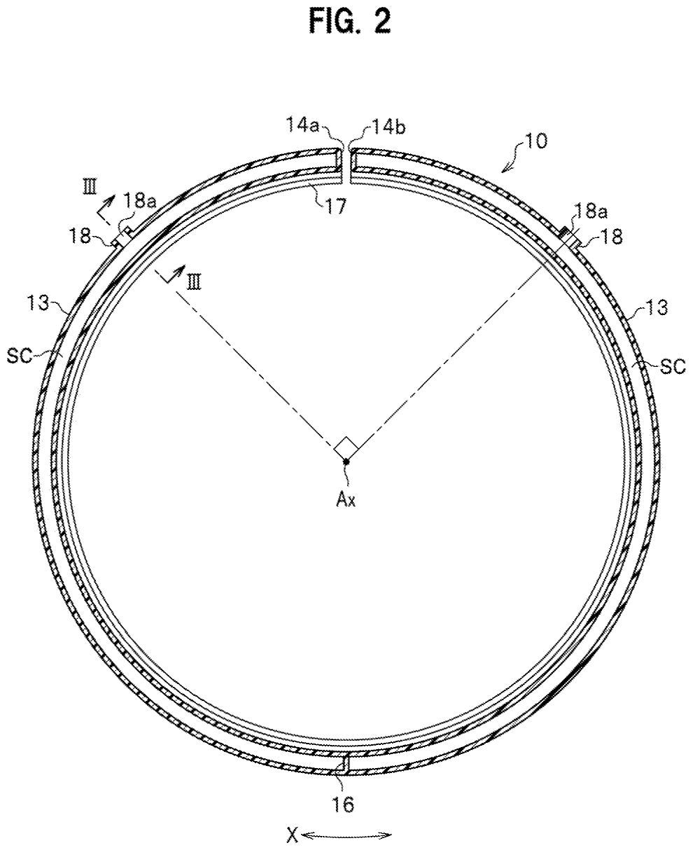

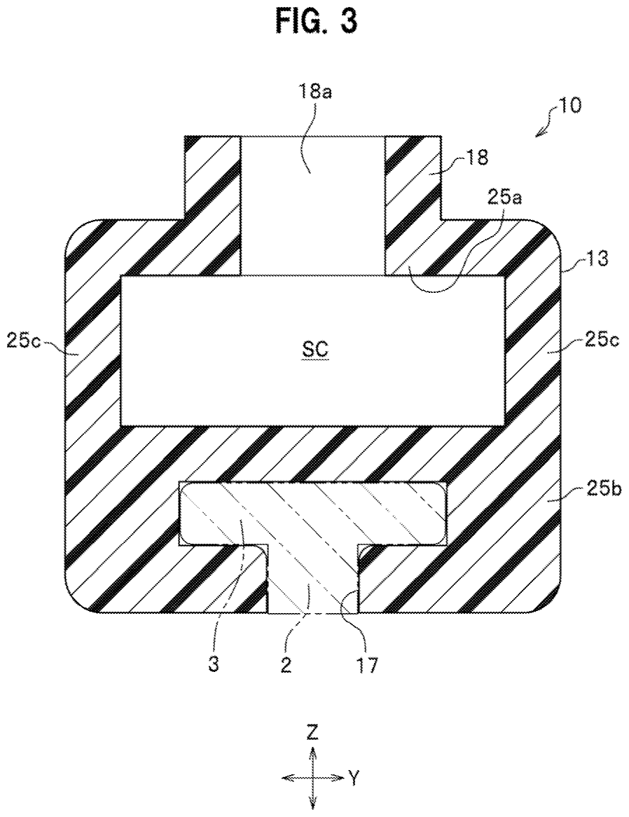

FIG. 2 is an enlarged cross-sectional view of a sub-air chamber member 10, taken along a lengthwise direction thereof. FIG. 3 is a cross-sectional view taken along line in FIG. 2.

As shown in FIG. 2, the sub-air chamber member 10 is a substantially annular member elongated in the wheel circumferential direction X.

As shown in FIG. 1, the sub-air chamber member 10 according to the present embodiment has substantially the same length as that of the later described guide member 2 and extends along the outer circumferential surface 11d of the well portion 11c over substantially the entire circumference of the outer circumferential surface 11d.

The sub-air chamber member 10 includes a main body portion 13 and tube bodies 18.

The main body portion 13 has a hollow space inside. This hollow space defines a sub-air chamber SC (see FIG. 3). This hollow space is partitioned by the partition wall 16 in the wheel circumferential direction X into two halves. Specifically, the main body portion 13 has a pair of sub-air chambers SC (see FIG. 2) extending in the wheel circumferential direction X with a partition wall 16 therebetween.

As shown in FIG. 3, the main body portion 13 has a substantially rectangular shape elongated in the wheel width direction Y in a cross-sectional view orthogonal to the longitudinal direction (wheel circumferential direction X shown in FIG. 2) of the main body portion 13.

Specifically, the main body portion 13 includes a bottom plate 25b extending along the outer circumferential surface 11d of the well portion 11c (see FIG. 1) and having widthwise ends located opposite each other in the wheel width direction Y, an upper plate 25a located substantially in parallel with the bottom plate 25b with a predetermined distance therebetween, and a pair of side plates 25c respectively rising substantially perpendicularly to and from the widthwise ends of the bottom plate 25b and joined to the upper plate 25a.

These upper plate 25a, bottom plate 25b, and side plates 25c define the pair of sub-air chambers SC inside the main body portion 13 in such a way as to surround the sub-air chamber SC.

The bottom plate 25b has a groove 17 formed therein corresponding to the later-described guide member 2. Incidentally, in FIG. 3, the guide member 2 is indicated by the imaginary line (alternate long and two short dashed line).

As shown in FIG. 2, the groove 17 extends in the main body portion 13 along the lengthwise direction (wheel circumferential direction) thereof.

Next, a description will be given of the tube body 18 (see FIG. 1).

As shown in FIG. 1, the tube body 18 is formed projecting from a surface of the main body portion 13 which is located outward in the wheel radial direction Z.

As shown in FIG. 2, each tube body 18 has a communication hole 18a defined therein.

The main body portion 13 according to the present embodiment defines a pair of the tube bodies 18 in such a way that their communication holes 18a respectively correspond to the pair of sub-air chambers SC.

The sub-air chambers SC and a not-shown tire air chamber communicate with each other via the communication holes 18a.

The pair of tube bodies 18 according to the present embodiment are arranged at positions spaced at a substantially 90-degree interval about the wheel rotation axis Ax. By arranging the tube bodies 18 (communication holes 18a) at such positions, the sub-air chamber member 10 can uniformly cancel the resonance noise generated in the tire air chamber and having a predetermined resonance frequency.

However, the number of the sub-air chambers SC and the positions of the tube bodies 18 are not limited thereto. When the number of the sub-air chambers SC is three or more, the tube bodies 18 can be arranged at regular intervals in the wheel circumferential direction X.

As shown in FIG. 3, the tube bodies 18 are each a cylindrical portion that projects from the upper plate 25a of the main body portion 13 outward in the wheel radial direction Z.

The shape of each tube body 18 is selected to design the opening area and the depth of the communication hole 18a of the tube body 18, which determine the resonance frequency of the Helmholtz resonator (sub-air chamber member 10).

### Guide Member

The guide member 2 of the present embodiment has a T-shaped cross section in cross-sectional view taken in a plane perpendicular to the wheel circumferential direction X (see FIG. 1), as indicated by the imaginary line (alternate long and two short dashed line) in FIG. 3.

As shown in FIG. 3, the guide member 2 includes an engaging portion 3 that fits into and engages with the groove 17 formed in the main body portion 13.

The engaging portion 3 corresponds to the horizontal bar portion of the T-shaped cross section of the guide member 2.

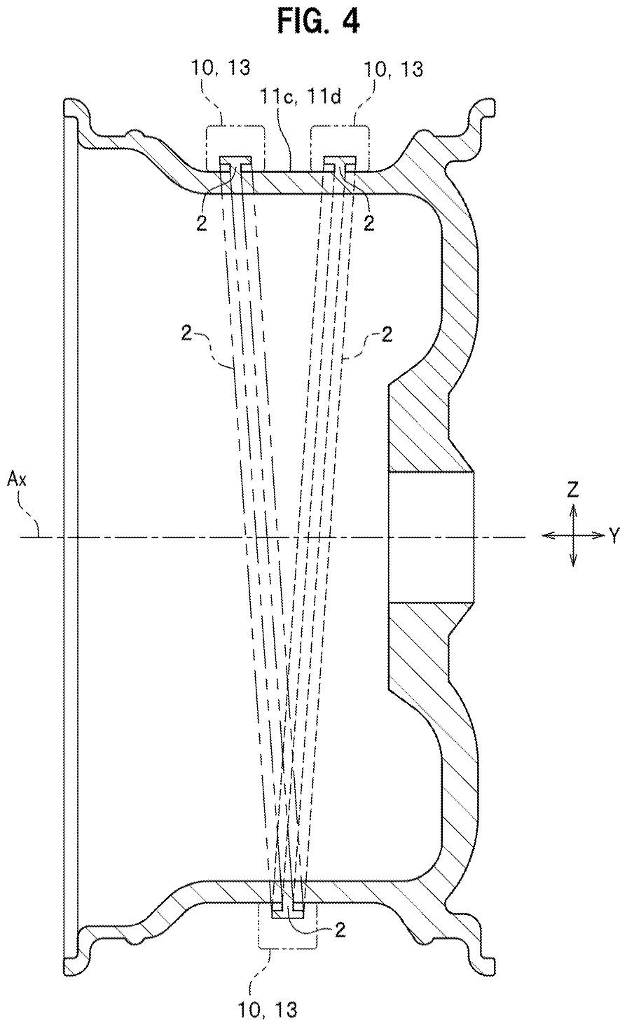

FIG. 4 is a cross-sectional view of the vehicle wheel 1, taken along a plane including the wheel rotation axis Ax (see FIG. 2). FIG. 4 illustrates how the guide member 2 extends.

In FIG. 4, the main body portion 13 of the sub-air chamber member 10 guided by the guide member 2 is indicated by an imaginary line (alternate long and two short dashed line).

As shown in FIG. 4, the guide member 2 according to the present embodiment is formed in a rail-like shape that extends in the wheel circumferential direction X (see FIG. 1) over substantially the entire circumference of the outer circumferential surface 11d of the well portion 11c.

In FIG. 4, the guide member 2 is drawn in two parts, one with imaginary lines (alternate long and two short dashed lines) and the other with hidden lines (dashed lines). The part drawn with the imaginary lines extends on the outer circumferential surface 11d on the front side of the drawing sheet of FIG. 4. The part drawn with the hidden lines extends on the outer circumferential surface 11d on the back side of the drawing sheet of FIG. 4.

The guide member 2 according to the present embodiment extends in a direction defining a predetermined angle with the wheel rotation axis Ax in such a way as to form a thread pitch of a screw.

Thus, the guide member 2 has one end portion 2a and the other end portion 2b which are located opposite each other in the wheel circumferential direction x and which are spaced apart from each other in the wheel width direction Y (see FIG. 1).

### Method of Attaching Sub-Air Chamber

Next, a description will be given of a method of attaching the sub-air chamber member 10 to the rim 11 (see FIG. 1).

According to this attachment method, firstly, one end portion 14a and the other end portion 14b of the sub-air chamber member 10, shown in FIG. 2, are brought apart from each other. Thereafter, the one end portion 2a of the guide member 2, shown in FIG. 1, is inserted into the groove 17 of the sub-air chamber member 10, shown in FIG. 2, from the one end portion 14a of the sub-air chamber member 10.

Next, the sub-air chamber member 10, shown in FIG. 2, is made to slide along the direction in which the guide member 2 extends as shown in FIG. 4, so that the guide member 2 is inserted through the groove 17 of the sub-air chamber member 10 over the entire length of the groove 17.

The series of processes of the attachment method is completed when sub-air chamber member 10 has been arranged in such a way as to extend substantially the entire circumference of the outer circumferential surface 11d of the well portion 11c, i.e., the length corresponding to the circumferential length of the guide member 2, as shown in FIG. 1.

### Operations and Advantageous Effects

Next, a description will be given of operations and advantageous effects of the vehicle wheel 1 according to the present embodiment.

The vehicle wheel 1 according to the present embodiment includes the rail-like guide member 2 that can engage with the sub-air chamber member 10 and guide the sub-air chamber member 10 in the wheel circumferential direction X.

The sub-air chamber member 10 is attached to the rim 11 of the vehicle wheel 1 by being made to slide in the direction in which the guide member 2 of the vehicle wheel 1 extends and thereby engage with the guide member 2.

Therefore, according to the structure of the vehicle wheel 1, unlike the conventional vehicle wheels (e.g., see Japanese Patent No. 4551422), the sub-air chamber member 10 can be attached to the rim 11 extremely easily, without the help of a tool such as a pusher that provides a mechanical force.

In addition, according to the structure of the vehicle wheel 1, as the engaging portion 3 of the guide member 2 is fitted into the groove 17 of the sub-air chamber member 10, the vehicle wheel 1 is excellent in retaining the sub-air chamber member 10 on the well portion 11c.

According to the structure of the vehicle wheel 1 of the present embodiment, the guide member 2 extends on the outer circumferential surface 11d of the well portion 11c over substantially the entire circumference of the outer circumferential surface 11d, and the sub-air chamber member 10 has a circumferential length substantially corresponding to the circumferential length of the guide member 2 and extends along the outer circumferential surface 11d of the well portion 11c over substantially the entire circumference of the outer circumferential surface 11d.

As the sub-air chamber member 10 of the vehicle wheel 1 extends along the outer circumferential surface 11d of the well portion 11c over substantially the entire circumference of the outer circumferential surface 11d, the sub-air chamber SC can be made larger than when a sub-air chamber member is arranged only over a partial area of the outer circumferential surface 11d of the well portion 11c.

Accordingly, the vehicle wheel 1 can provide improved performance of noise cancellation.

The guide member 2 of the vehicle wheel 1 of the present embodiment has the one end portion 2a and the other end portion 2b, which are located opposite each other in the wheel circumferential direction X and are spaced apart from each other in the wheel width direction Y.

According to the structure of the vehicle wheel 1 of the present embodiment, the sub-air chamber member 10 can be attached to the guide member 2 without the one end portion 14a and the other end portion 14b of the sub-air chamber member 10 interfering with each other.

Although an embodiment of the present invention has been described, the present invention is not limited to the embodiment described above and can be carried out in various modes.

Although the guide member 2 of the above-described embodiment has been described as having the T-shaped rail, the present invention is not limited thereto. The guide member 2 of the present member is not limited so long as the guide member 2 extends from the outer circumferential surface 11d of the well portion 11c in the radially outward direction and has a proximal portion on a side of the outer circumferential surface 11d and a distal end portion located on a radially outer side of the proximal portion and having a larger width than the proximal portion. For example, the guide member 2 can be a rail having a reversed L-shaped cross section or can be a rail with a cross section having an expanded portion at a distal end.

The guide member 2 of the above-described embodiment has been described as extending continuously in the wheel circumferential direction X. However, according to the present invention, guide members intermittently extending in the wheel circumferential direction X can be used in place of the guide member 2.

The sub-air chamber member 10 according to the above-described embodiment is assumed to extend in the wheel circumferential direction X over substantially one circumference. However, the length of the sub-air chamber member 10 may be smaller than the one circumference such that the one end portion 14a and the other end portion 14b of the sub-air chamber member 10 are slightly spaced apart from each other in the wheel circumferential direction X.

Conversely to this, the sub-air chamber member 10 may extend more than one circumference of the outer circumferential surface 11d of the well portion 11c, so long as the angle interval between the communication holes 18a is 90 degrees.

The one end portion 2a and the other end portion 2b of the guide member 2 of the vehicle wheel 1 according to the above-described embodiment have been described as located opposite each other in the wheel circumferential direction X and spaced apart from each other in the wheel width direction Y. However, the present invention is not limited thereto.

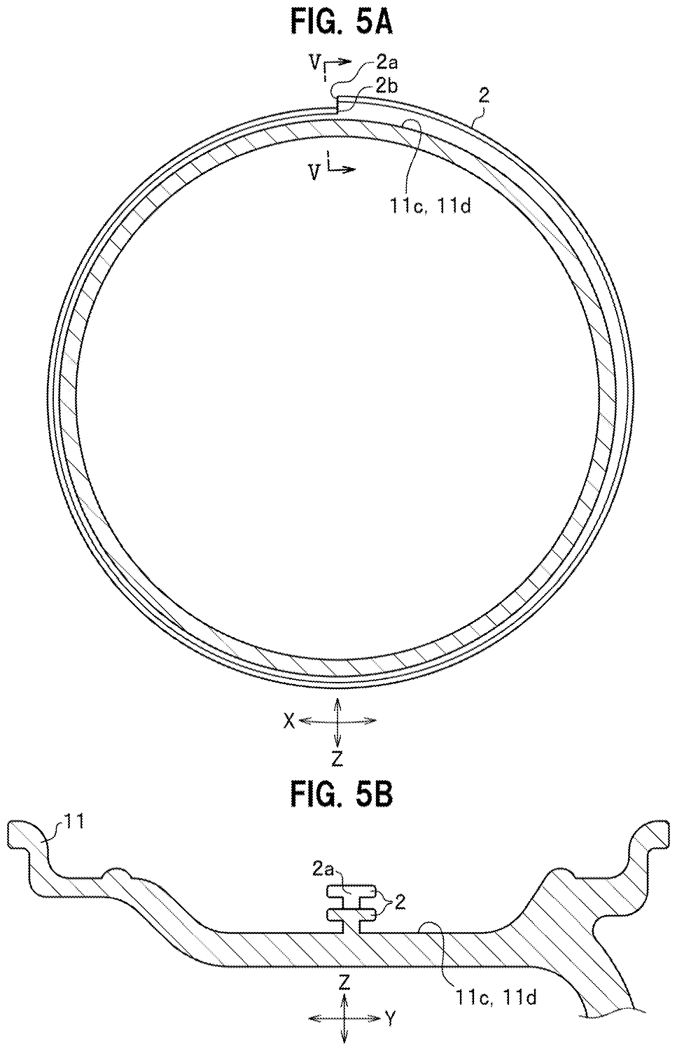

FIG. 5A is a side view of a guide member 2 according to a modification. FIG. 5B is a cross-sectional view taken along line V-V in FIG. 5A. Note that constituent elements shown in FIGS. 5A and 5B which are the same as those in the above-described embodiment are denoted by the same reference numerals and detailed descriptions thereof will be omitted.

As shown in FIGS. 5A and 5B, the guide member 2 has one end portion 2a and the other end portion 2b spaced apart from each other in the wheel radial direction Z.

According to the structure of the guide member 2 according to the modification, the sub-air chamber member 10 can be attached to the guide member 2 without the one end portion 14a (see FIG. 2) and the other end portion 14b (see FIG. 2) of the sub-air chamber member 10 interfering with each other.

Although illustration is omitted, the guide member 2 may have one end portion 2a and the other end portion 2b spaced apart from each other in both the wheel width direction Y and the wheel radial direction Z.

Although illustration is omitted, the guide member 2 may have one end portion 2a and other end portion 2b spaced apart from each other in the wheel circumferential direction X.

In addition, a rotation stop maybe provided between the sub-air chamber member 10 and the rim 11 and/or between the sub-air chamber member 10 and the guide member 2.

What is claimed is:

1. A vehicle wheel comprising:
a rim comprising a well portion and a guide member, the well portion having an outer circumferential surface extending in a wheel circumferential direction of the vehicle wheel, the guide member having a rail-like shape and extending in the wheel circumferential direction along the outer circumferential surface; and
a sub-air chamber member serving as a Helmholtz resonator,
wherein the guide member engages with the sub-air chamber member to guide the sub-air chamber member in the wheel circumferential direction, thereby to attach the sub-air chamber member to the rim.

2. The vehicle wheel of claim 1,
wherein the guide member extends on the outer circumferential surface of the well portion over substantially the entire circumference of the outer circumferential surface, and
wherein the sub-air chamber member has a circumferential length substantially corresponding to a circumferential length of the guide member and extends along the outer circumferential surface of the well portion over substantially the entire circumference of the outer circumferential surface.

3. The vehicle wheel of claim 1,
the guide member has a first end and a second end which are located opposite each other in the wheel circumferential direction, the first and second ends spaced apart from each other in a wheel width direction of the vehicle wheel and/or in a wheel radial direction of the vehicle wheel.
